(19) United States
(12) Patent Application Publication
(10) Pub. No.: US 2023/0360487 A1
(43) Pub. Date: Nov. 9, 2023

(54) BETTING MARKETS

(71) Applicant: Cornelius Johannes COETZER, Ceres (ZA)

(72) Inventor: Cornelius Johannes COETZER, Ceres (ZA)

(21) Appl. No.: 18/040,612

(22) PCT Filed: Aug. 4, 2021
(86) PCT No.: PCT/IB2021/057140

§ 371 Date: Feb. 3, 2023

(30) Foreign Application Priority Data
Aug. 4, 2020 (ZA) 2020/04815

(51) Int. Cl. G07F 17/32

(52) U.S. Cl. CPC G07F 17/3288; G07F 17/3258

(57) ABSTRACT

The invention provides for a computer-implemented method of administering a betting market for sports, the method includes the steps of receiving game details for a game between two parties, which includes probabilities of each outcome in an array of possible outcomes of the game, calculating an array of odds on the game details and determining a pivot in the array of possible outcomes based on the array of odds, with a first and second group of outcomes defined on opposing sides of the pivot, respectively, or on the pivot. Thereafter, bets are received from participants, each bet relating to either the first or second group of outcomes, until a predefined cut off time or outcome, whereafter a game outcome is received, and a reward is calculated for those participants who betted on the group outcome in which the game outcome falls, based on the odds calculated for the game outcome.

### FIELD OF THE INVENTION

This invention relates to betting markets. In particular, the invention relates to a method of administering a betting market for sports or electronic sports (e-sports) and a betting system capable of operating a betting market for sports or e-sports.

### BACKGROUND OF THE INVENTION

Conventional sports wagering systems allow a person to wager an amount of money on a predicted outcome of an event (a “wager”), typically informed by a statistical probability of that particular outcome occurring. The implied probability of a particular outcome is typically reflected in the odds provided by the bookmaker, which indicates of the amount of payout (including profit, if any) payable to the punter in the event of a successful outcome (i.e. a winning bet).

Wagers are made on particular betting markets, which offer predetermined odds for predefined outcomes of the particular event. Examples of popular betting markets include: the “match result” betting market, wherein wagers are directed at a prediction of the outcome of the match selected from home win, draw, or away win; the “total points” betting market, wherein wagers are directed at over or under a predetermined point line; the “Asian handicaps” betting market, wherein wagers are directed at plus or minus; the “correct score” betting market, wherein wagers are directed at a predicted final score of the game; the “first goal scorer” betting market, wherein wagers are directed at a prediction of the first team or player to score a goal in the game; and the “half time result” betting market, wherein wagers are directed at a predicted half time result selected from home ahead, draw or away ahead.

The odds in these so-called fixed-odds wagering systems are determined by bookmakers or betting houses based on the statistical probability of each of the predefined outcomes realising. Bookmakers can also use historical data gathered on their client's betting patterns to forecast which side of the market will obtain the largest portion of wagers. Bookmakers can adjust the odds accordingly, thereby deviating from the true odds, in order to minimise their risk. Bookmakers also include a vigorish (also known as margin) into the odds offered to punters. A vigorish is a deviation from the true odds where the bookmakers offer a slightly smaller payout than what they deem to be the true odds. The vigorish is a commission taking by the bookmakers for taking the bets.

When a person wagers on an outcome which realises, the result is a payout based on the initial wagered amount and the associated odds. However, when a person wagers on an outcome which does not realise, he/she will typically lose the entire wagered amount. In other markets, such as “draw no bet”, which is popular in football, in the event of a draw the bet is declared void and the participant's stake is returned.

One alternative to the aforementioned fixed-odds systems is a spread betting wherein, for example, a person wagers on a predicted outcome based on a predetermined spread. In such systems, the odds are not based on a definitive outcome but a spread or prediction of what may occur in a game (e.g. how many goals scored in a hockey match, a bookmaker can predict 3 goals to be scored in a match at a spread of 2.8-3). A person will “buy” on the spread or prediction determined by a bookmaker if they wish to wager on the outcome of the game realising more or higher than the spread or prediction (e.g. the person will “buy” at 3). Alternatively, a person will “sell” on the spread or prediction if they wish to wager on the game outcome realising less than the spread or prediction (e.g. the person will “sell” at 2.8). Payouts are based on the accuracy of the wager on a linear scale and not fixed odds. In particular, payouts are calculated as follows: (game outcome less the buy price) multiplied by stake wagered. For example, if a person placed a R10 “buy” bet at 3, and 7 goals are scored in the match, they would receive a payout of R40 ((7-3)×R10). Therefore, a larger payout will be due to participants with winning bets as the margin of the “buy” into a particular outcome, spread or prediction, appropriately, increases. A participant can thus win multiples of their initial amount wagered. However, the major drawback of these spread betting systems is that they also result in a complete loss of the wagered amount if the predicted margin is not realised. In some instances, as the accuracy of the predicted outcome decreases, a greater loss than the initial wagered amount ensues (i.e. the punter is left in debt) and an unsuccessful participant can even lose multiples of the initial amount wagered. For example, continuing the example above, if zero goals are scored in the match, the person having a R10 “buy” bet at 3 will lose R30 ((0-3)×R10). For this reason, spread betting is illegal in certain jurisdictions.

The inventor is aware of the various conventional wagering systems and betting markets available and has identified a need for a novel system which ensures that in the case of a predicted outcome not realising, the entire wagered amount is not necessarily lost by the participant who placed the wager and it is never possible for the punter to lose more than the wagered amount. Whilst, in the event of a winning wager, the payout amount increases exponentially to the margin of victory of the team or player which was wagered on. It is an objective of the present invention to address this need.

### SUMMARY OF THE INVENTION

According to a first aspect of the invention, there is provided a computer-implemented method of administering a betting market for sports, the method including the steps of:
receiving game details for a game between two parties, the game details including at least probabilities of each outcome in an array of possible outcomes of the game;
calculating an array of odds based on the game details;
determining a pivot in the array of possible outcomes based on the array of odds, with a first group of outcomes defined on one side of the pivot and a second group of odds defined on an opposed side of the pivot;
receiving bets from a plurality of participants, each bet relating to either the first group of outcomes or the second group of outcomes, until a predefined cut off time (associated with the outcome);
receiving a game outcome associated with a particular outcome in the array of possible outcomes, the game outcome falling within any one of the first group of outcomes, the second group of outcomes, or on the pivot; and
calculating rewards due to participants, wherein at least those participants who bet on the group of outcomes in which the game outcome falls are rewarded based on the odds calculated for the game outcome.

It is to be appreciated that in this specification, the term “party” may denote a single player forming each party (e.g. tennis), multiple players in a team forming each party (e.g. rugby), or the like. The term “sports” is intended to include e-sports, online sports, online games, non-sporting events, or the like.

The term game in this specification is used to refer to a game/match/race between one or more parties in sports (as defined above).

The method may include an event where there are no rewards due to participants when the outcome lands on the pivot in the array of outcomes.

The method may include the prior step, before the step of receiving game details, of calculating probabilities of each possible outcome in an array of possible outcomes of the game statistically.

The step of calculating the probabilities of each possible outcome may include receiving statistical data from a third party and running the statistical data through an algorithm to determine the probabilities of each outcome.

The step of receiving game details may include receiving game details from an administrator.

The step of receiving game details may include receiving game details from a third-party database.

The game details may include any one or more of: party names, game date, game time, the cut off time for betting, or the like.

The step of calculating the array of odds for the array of possible outcomes of the game may include determining the array of possible outcomes.

The array of possible outcomes may depend on any one or combination of: a sport which will be played, a game format of the sport, and a particular market (e.g. an over/under market) to be offered for the game.

The first group of outcomes and the second group of outcomes may be capped at a predetermined range from the pivot. The term capped means that all outcomes beyond a certain point in the array of possible outcomes will receive the same rewards that are due to participants.

The first group of outcomes and the second group of outcomes each may include two or more possible outcomes for the game, with each outcome having particular odds.

The first group of outcomes and the second group of outcomes may be divided into margin of win outcomes respectively, with each margin forming an element in the array of possible outcomes and providing a particular outcome of the game.

The elements in the array of possible outcomes or particular outcomes may be arranged sequentially on either side of the pivot.

Any one of the elements in the array of possible outcomes and particular outcomes may be grouped in a range of discrete outcomes (e.g. 10-15 points difference, 15-20 points difference, etc.).

In use, any one of the first group of outcomes and the second group of outcomes may be bet on by a participant. For example, in an embodiment of a game between two teams where the pivot falls coincidentally on a draw between the two teams, the array of possible outcomes is divided into the first group of outcomes in which a first team wins, an outcome which is a draw (the pivot) between the first team and a second team and the second group of outcomes in which the second team wins. If a participant bets on the first group of outcomes, the participant bets on the first team winning. As the first group of outcomes and the second group of outcomes are divided into margin of win outcomes, if the first team wins by a certain margin, the reward due to the participant will be calculated based on the odds in the array of odds associated with that particular outcome (representing the margin of win or the element in the array of possible outcomes).

The odds may include an amount wagered by all the participants (i.e. odds including stake).

The odds may exclude an amount wagered by all the participants (i.e. odds excluding stake).

The step of calculating the array of odds for the array of possible outcomes of the game may be based on any one of historical betting patterns of a bookmaker's clients and an incorporation of a vigorish (VIG) into the array of odds.

The step of calculating the array of odds for the array of possible outcomes of the game may be executed iteratively each time a participant accesses or views the array of odds. It is to be appreciated that the probability of each particular outcome may vary over time and as such, calculating the array of odds for the array of possible outcomes may be iterated accordingly.

The method may include the intermediate step after the step of calculating the array of odds, of storing the array of odds for the array of possible outcomes in an odds database in the form of a digital storage facility.

The digital data storage facility may be in the form of a server, particularly a remote server.

The odds database may include the array of possible outcomes of the game and the array of odds associated with each possible outcome, as calculated.

The step of determining a pivot in the array of possible outcomes may include determining an outcome which will distinguish between the first group of outcomes and the second group of outcomes.

The pivot may represent a point in the array of possible outcomes for the game where participants who wagered on the first group of outcomes will lose the entire amount wagered if the game outcome goes past the pivot into the second group of outcomes, and in which participants who wagered on the second group of outcomes will lose the entire amount wagered if the game outcome goes past the pivot and results in a game outcome that falls in the first group of outcomes.

The pivot may fall on or between a particular outcome with its associated odds.

The pivot may be determined based on any one or more of the most likely outcome for a game, prior knowledge of the prevailing betting trends of participants and a predicted outcome where equal amounts of wagers are placed on either side of the pivot. For example, in some embodiments the pivot may be determined as a draw in a game between two parties regardless of whether the parties are evenly matched or whether one party is the favourite to win.

The pivot may be determined at the spread line representing the expected margin of victory or total amount of goals/points expected to be scored.

The odds for each possible outcome in the first group of outcomes and the second group of outcomes, respectively, may increase from a first odd adjacent the pivot outwards in the array of odds, corresponding with the probability of such outcomes realising and forming the game outcome.

The step of receiving bets from a plurality of participants may include receiving from each participant at least event details, an identifier of the participant, a bet indicator and an amount wagered by the participant (a stake).

The bet indicator may be associated with any one of the first group of outcomes and the second group of outcomes.

The step of receiving bets from a plurality of participants may include receiving for each bet made by a participant a unique indicator associated with that bet.

Depending on the array of possible outcomes and the pivot, the bet indicator may relate to any one of a predicted winning party (e.g. where the pivot is a draw between two parties) and any one of a points, goal, run difference between the parties (e.g. where the betting market is an over/under market).

The bet indicator which is associated with either the first group of outcomes or the second group of outcomes, may be associated with odds associated with that group of outcomes, the odds corresponding to any one of the margin of win within the group of outcomes and a total count of an occurrence of a predefined event.

The method may include bets related to the pivot, which falls between the first group of outcomes and the second group of outcomes.

The step of receiving bets from a plurality of participants may include retrieving from the odds database the odds of the possible outcomes in the group of outcomes wagered on at the time of the bet of each participant.

The method may include the intermediate step of storing the bets received from the plurality of participants on a game wagers database in a digital storage facility, after the step of receiving bets from a plurality of participants.

The game wagers database may include at least an identifier of the participant, a bet indicator indicating the group of outcomes wagered on, the event details and an amount wagered by the participant.

The game wagers database may further include the odds of the possible outcomes in the group of outcomes wagered on by the participant for that bet.

The game outcome may be received at any one of: after the game has occurred, at halftime, after a prescribed event in the game (e.g. a set), or the like.

The game outcome may include any one or more of: a game winner, a margin of win, a point, run, goal, time difference, totals for any specified duration of time or events, and an event in a game.

The game outcome may include any one or more of: a game winner, a margin of win, a point difference, an event in a game, or the like.

The game outcome may include any one of a name of a first goal scorer, a halftime score, a set score, or the like. It is to be appreciated that the game outcome may be received as a game score at any point during or after the game.

The game outcome may fall on the pivot, falling outside both the first group of outcomes and the second group of outcomes. It is to be appreciated that in this instance, participants may still receive a reward. The reward may be equal to or less than the initial amount wagered by that participant.

The step of receiving a game outcome may further include storing the game outcome on the game wagers database associated with the particular game.

The rewards due to participants who bet on the group of outcomes in which the game outcome falls may be calculated based on the odds in the array of odds for the game outcome realising, with a greater margin resulting in a greater reward. For example, in the embodiment of a game between two teams where the pivot falls on a draw between the two teams (mentioned above), if a participant wagered on the first group of outcomes in which a first team wins, and the first team wins, the odds of the margin of win will determine the reward. A greater margin of win will result in a greater reward.

The rewards may be in the form of any one of credits, payouts, tokens, vouchers, or the like.

The rewards may be in the form of credits allocated to an electronic wallet, from which monetary payouts can be requested by a participant.

The method may include the subsequent step of facilitating reward transfers to the plurality of participants with bets on the game.

The step of facilitating reward transfers may include effecting a monetary transaction to the benefit of a particular participant.

The step of facilitating reward transfers may include allocating any one of a token, a voucher and a credit amount to an electronic account in the name of the participant.

The step of facilitating reward transfers may include storing reward receipts on the game wagers database after rewards have been transferred to participants.

According to a second aspect of the invention, there is provided a betting system capable of operating a betting market for sports, which includes
a digital storage facility for storing executable instructions, which when executed performs the steps of:
   receiving game details for a game scheduled between two parties, the game details including at least probabilities of each outcome in an array of possible outcomes of the game;
   calculating an array of odds for the array of possible outcomes of the game based on the game details, with the odds for each particular outcome in the array of possible outcomes being based on at least a probability of each particular outcome;
   determining a pivot in the array of possible outcomes based on the odds, with a first group of outcomes defined on one side of the pivot and a second group of odds defined on an opposed side of the pivot;
   receiving bets from a plurality of participants, each bet relating to either the first group of outcomes or the second group of outcomes, until a predefined cut off time before the start of the game;
   receiving a game outcome associated with a particular outcome in the array of possible outcomes, the game outcome falling within either the first group of outcomes or the second group of outcomes or the pivot; and
   calculating rewards due to participants, wherein at least those participants who bet on the group of outcomes in which the game outcome falls are rewarded based on the odds calculated for the game outcome.
a processor which is operable to execute the executable instructions, the processor being hosted on a server; and
a plurality of user devices which are in communication with the server and on which participants can place their bets.

The server may be in the form of a remote server. The remote server may be cloud-based.

The plurality of user devices may be in the form of any one of: mobile telephones, personal computers, iPad's, point of sales devices, or the like.

The plurality of user devices may be in communication with the server over the Internet.

The digital storage facility may further store executable instructions, which when executed performs the further steps of:
storing the array of odds associated with each possible outcome in the array of possible outcomes in an odds database;
storing the bets received from the plurality of participants on a game wagers database; and
facilitating reward transfer to the plurality of participants with bets on the game, or the like.

The betting system may further include any one or both of: an odds database, a game wagers database or the like, hosted on the digital storage facility.

The invention is now described, by way of non-limiting example, with reference to the accompanying figures.

### FIGURE(S)

In the figure(s):

FIG. 1 shows a flow-diagram of the steps of a method of administering a betting market for sports or e-sports, in accordance with one aspect of the invention;

FIG. 2 shows a table illustrating the step of calculating the odds for the array of outcomes in further detail;

FIG. 3 shows a table illustrating one example of a odds database;

FIG. 4 shows an example of the odds provided for the array of outcomes in the present invention (indicating the pivot falling on a draw and the first group of outcomes being the Team A win and the second group of outcomes being the Team B win) as compared to the prior art betting markets in a football example;

FIG. 5 shows another example of the odds provided for the array of outcomes in the present invention (indicating the pivot falling on Team A to win by 6-points and the first group of outcomes being Team A win by 11-15 points or more and the second group of outcomes being Team A win by only 1-5 points, draw or Team B win by any margin) as compared to the prior art betting markets in a football example;

FIG. 6 shows a table illustrating one example of a game wagers database; and

FIG. 7 shows a component diagram of a betting system capable of operating a betting market for sports or e-sports, in accordance with a further aspect of the invention.

In the figures, like reference numerals denote like parts of the invention unless otherwise indicated.

### EMBODIMENT OF THE INVENTION

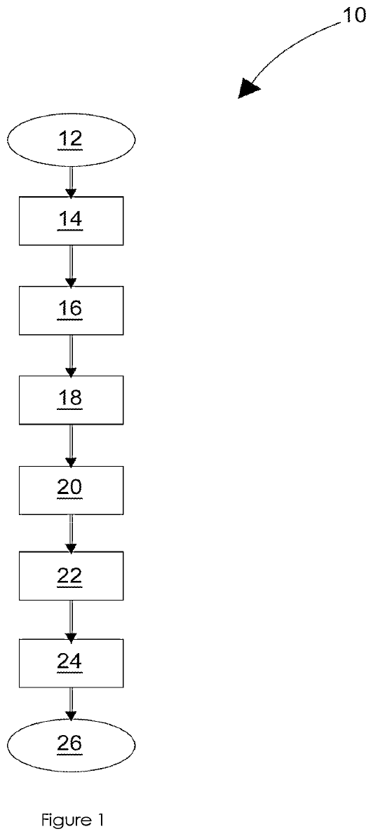

In FIG. 1, reference numeral 10 refers to a method of administering a betting market for two team games. This betting market provides a so-called “hybrid” wagering system, having features of both a match result betting market and an Asian handicap betting market. The major advantage of this “hybrid” wagering system is that greater rewards are due to participants with winning bets in the case of a larger margin of win. As participants have full access to view the odds offered for the various margins of win before placing a bet, it is believed that this feature will make the method (10) more attractive for participants to participate in. In this example, the method (10) provides an online betting market which is run by an administrator who represents a bookmaker. The method (10) includes various steps labelled 12 to 26. The method (10) starts at 12.

The betting market administered through the method (10) is limited to games in which two parties participate (i.e. either two team games such as rugby, soccer, basketball, National Football League or National Hockey League, Defense of the Agents (DotA) or League of Legends (LOL), or two player games such as tennis, squash or e-sports). Such two party games provide a suitable contingency for betting as the outcome of a particular game is uncertain or unknown prior to the game, when bets are placed. However, there are a number of outcomes for each game which can be defined for the contingency and on which bets can be placed. For example, three possible match result outcomes can be defined for a football game: home team win, away team win and draw. In another example, eight possible outcomes made up of ranges of points can be defined for an ice hockey game: home team win by 7 or more; home team win by 5-6; home team win by 3-4; home team win by 1-2; draw; away team win by 1-2; away team win by 3-4; away team win by 5-6 away team win by 7 or more. In yet another example, two possible outcomes can be defined for an over/under market for total points in a rugby, NFL or other game: if the pivot is placed on 49.5 points, the possible game outcomes on one side of the pivot (i.e. first group of outcomes) can look something like: 29 or less; 30-34; 35-39; 40-44; 45-49. On the other side of the pivot, the second group of outcomes can look something like 50-54; 55-60; 61-65; 66-70; 71 or more. The game outcome is the result after the contingency has occurred and traditionally, participants who successfully predict the game outcome (from the possible outcomes) are rewarded with a payout on their winning bet.

At 14, the method (10) includes the step of receiving game details for a game scheduled between two parties. In this example, game details are received from an administrator and include team names (or player names), game date, game time, the cut off time for betting (based on the game date) and importantly, the probabilities of each outcome in an array of possible outcomes of the game. It is to be appreciated that this step will employ automated means of receiving game details from external sources, such as websites or databases on which such game details are stored or published. These automated means may include Application Programming Interfaces (API's), website scrapers, or the like.

In other examples, the method can include the prior step, before step 14, of calculating the probabilities of each outcome in an array of possible outcomes of the game statistically. However, as these statistical probabilities are available from third parties in this example, this step is not necessary and such probabilities can be retrieved from a suitable third-party database by the administrator.

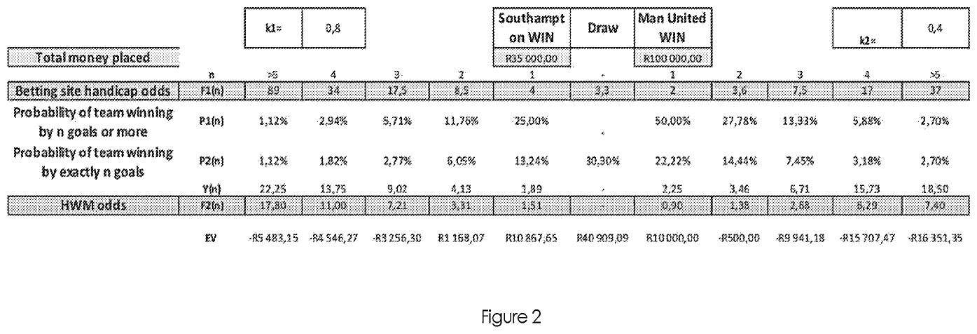

At 16, the method (10) includes the step of calculating an array of odds for the array of possible outcomes of the game based on the game details. The array of odds determine the reward due to a participant after the game. The odds for each particular possible outcome in the array of possible outcomes is based on a probability of each particular possible outcome, as well as known betting patterns of participants and a vigorish (VIG) calculation (detail below) endeavouring to make a profit for the betting house. The calculation of the odds (16) is shown in FIG. 2.

In FIG. 2, “n” is the number of goals by which Team A or Team B ends up winning. It is to be appreciated that “n” can also be represented as point brackets for higher scoring sports or e-sports (e.g. 1-5 points, 6-10 points, etc.). F₁(n) are the probabilities of each outcome received from the third party for the asian handicap markets and inserted by the administrator in this example. These probabilities are leveraged and reworked through multiple mathematical and statistical methods to generate the new odds for the present invention.

P₁(n) are the probabilities of the relevant team winning by n goals or more. This is calculated by the multiplicative inverse of F₁(n) (therefore, P₁(n)=1/F₁ (n)). P₂(n) are the probabilities of the relevant team winning by exactly n goals. This is calculated by subtracting the probability of the relevant team winning by n−1 goals or more from the probability of the relevant team winning by n goals or more (therefore, P₂(n)=P₁(n)−P₁(n−1)). Y(n) are the ratios of the probabilities of the relevant team winning by the various n goals compared to the probability of the particular n (therefore, ( . . . P₂(n−2)+P₂(n−1)+P₂(n)+P₂(n+1)+P₂(n+2) . . . )/P₂(n)). The k values (k₁ and k₂) are statistical values used in the calculation of F₂(n) as described below. “k” is the multiplicative inverse of the sum of ( . . . Y(n−2)*P₂(n−2)+Y(n−1)*P₂(n−1)+Y(n)*P₂(n)+Y(n+1)*P₂(n+1)+Y(n+2)*P₂(n+2) . . . ) (therefore, k=1/( . . . Y(n−2)*P₂(n−2)+Y(n−1)*P₂(n−1)+Y(n)*P₂(n)+Y(n+1)*P₂(n+1)+Y(n+2)*P₂(n+2) . . . )). k₁ is in respect of a Southampton win and k₂ is in respect of a Man United win. F₂(n) are the market odds offered by the present invention, referred to as the Hybrid Wager Market (HWM), to participants. The odds offered relate to which team will win and by n many goals. F₂(n) is calculated by multiplying Y(n) by k for each outcome (therefore, F₂(n)=Y(n)*k). It is to be appreciated that k₁ is used for the odds for a Southampton win, whereas k₂ is used for the odds for a Man United win. As shown, one of the differentiators of this market is that it provides participant with major upside potential without increasing the downside probability.

The “EV” is the expected value, the amount of money that the bookmaker would stand to win or lose for a given outcome. The EV takes into account the probability of the outcome and the money that was bet on either side of the market. In this example, when a game results in a draw, the bookmaker makes the most money. The F₁(n) value for a draw shows there is a 30% probability of the game ending in a draw. Therefore, 30% of the time the bookmaker will win R35,000+R100,000 and thus the EV is 0.3*(R35,000+R100,000)=R40,909. A negative EV means the bookmaker will lose money when this outcome realises. However, the probability of this outcome realising is small and in the long run, the more likely probabilities where the bookmaker makes a profit will occur more often, meaning that the bookmaker will make an overall profit.

It is to be appreciated that the vigorish (or “VIG”, the commission paid to the bookmaker on each bet placed) can be calculated from these values. The Rand values shown under “Southampton WIN” and “Man United WIN” depict a hypothetical sum of bets placed on each side of the Hybrid Wager Market by participants. For the purpose of illustrating that the Hybrid Wager Market has a built-in constant VIG, these Rand values can be adjusted to show that based on the expected value theorem the VIG will indeed remain constant. As is the case with all betting markets, it is not possible to forecast or determine the exact amount of money that will be placed on each side of the betting market. Therefore it is preferable for some bookmaker to adjust the vig in accordance to the relevant distribution of revenue on each outcome, to maximise the probability of making a profit.

In this method (10), the odds include the amount wagered by the participant (i.e. odds including stake). For example, odds of 4.2 including stake would indicate that for each amount wagered by the participant in the bet, the payout amount would be 4.2 times that amount on a winning bet—the participant therefore receiving the amount wagered plus 3.2 times that amount in “profit”.

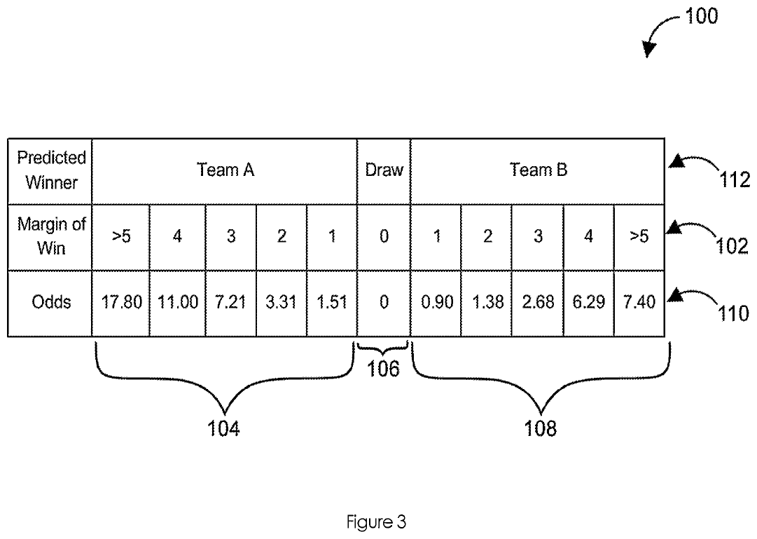

At 16, the method (10) also includes the step of determining a pivot in the array of possible outcomes based on the array of odds, with a first group of outcomes defined on one side of the pivot and a second group of odds defined on an opposed side of the pivot. This is exemplified in FIG. 3, wherein the array of possible outcomes (102) are grouped or divided into:
at 104, a first group of outcomes in which a first team wins (“Team A”);
at 106, a pivot which is a draw between the two teams (described below, distinguishing between a wager that results in a reward and a wager that results in a complete loss of the initial wagered amount); and
at 108, a second group of outcomes in which the second team wins (“Team B”).

The group of outcomes in which Team A wins (104) and the group of outcomes in which Team B wins (108) are further divided into margin of win outcomes respectively, with each margin forming an element in the array of possible outcomes (102) and providing a particular potential game outcome of the game. The margin of win outcomes (102) are arranged sequentially in the array, as shown.

It is to be appreciated that a participant would desire the largest possible reward or payout relative to the amount wagered in his/her bet, and therefore carefully considers the odds when selecting a betting market on which to place his/her bet. The following example of Adam illustrates a shortcoming in existing markets that offer high odds: Adam wishes to place a bet on a match between Team G and Team H. As Adam wants a big payout, he will bet on high odds. Bookmaker Bet123 offers various betting markets for this match. The betting market “total goals” offers the following odds: odds of 1.10 on over 0.5 goals in the match, odds of 1.85 on over 2.5 goals in the match and odds of 7.5 on over 5.5 goals in the match. Adam is not interested in the over 0.5 goals outcome, since the odds are very low and thus, his profit will be low (R100 profit from a R1,000 bet). The over 2.5 goals market is also not quite what Adam is looking for, since the odds are still relatively low and his profit will be low (R850 profit from a R1,000 bet). Adam sees the over 5.5. goals outcome is offering odds of 7.5 which looks enticing, but Adam knows that although the odds are high and he would receive a large profit (R6,500 from a R1,000 bet) in the event of a winning bet, there is an excessively high risk as it is unlikely that the match will have that many goals. The high odds are associated with high risk which is undesirable. This drawback is associated with all current betting markets which offer high odds. Adam would prefer high odds while mitigating the risk associated with the wager (as would any participant) and this is offered by the odds calculated in the Hybrid Wager Market of this invention.

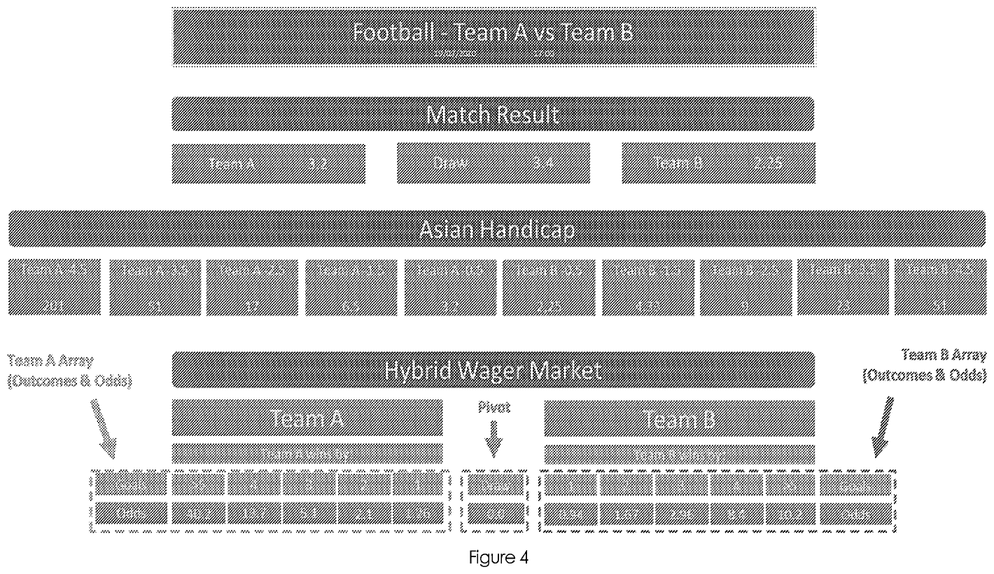

As is illustrated, the hybrid wager market of this invention offers the potential of receiving a large reward, while simultaneously mitigating the downside risk associated with the wager. This is specifically illustrated in FIG. 4, with an example of a football match between fictional Team A and B. In this example, Team B is the slight favourite for the match. Under the “Match Result” betting market, the odds offered for the three possible outcomes (team A win, draw and team B win) are shown. Under the “Asian Handicap” betting market, the odds offered for the ten possible outcomes (team A −0.5, −1.5, −2.5, −3.5, −4.5 and team B −0.5, −1.5, −2.5, −3.5, −4.5) are shown. Both of these markets form part of the prior art. When traditional markets, such as the “Asian Handicap” market, offer high odds they are associated with low probability outcomes, thus possess a high risk (as is the case for team A −1.5, −2.5, −3.5, −4.5 and team B −2.5, −3.5, −4.5 “Asian Handicap” markets). All current betting markets are limited in this sense.

For example, as shown in FIG. 4, under the “Asian Handicap” market, the bookmaker has set the ten outcomes and the associated odds for the Asian Handicap market as follows: (Team A −0.5 goals at odds of 3.2), (Team A −1.5 goals at odds of 6.5), (Team A −2.5 goals at odds of 17), (Team A −3.5 goals at odds of 51), (Team A −4.5 goals at odds of 201) and (Team B −0.5 goals at odds of 2.25), (Team B −1.5 goals at odds of 4.33), (Team B −2.5 goals at odds of 9), (Team B −3.5 goals at odds of 23), (Team B −4.5 goals at odds of 51). There is a large variety of outcomes to choose from in the “Asian Handicap” market. A participant might choose to wager on team A with a −2.5 goal handicap at odds of 17. Keep in mind that Team B is the slight favourite to win. If a participant places a bet on (Team A −2.5 goals), the participant predicts that Team A is going to win by more than 2.5 goals. Since half a goal cannot be scored in football, this means that the participant predicts that Team A will win by 3 or more goals (in a margin of win). Therefore, if a participant bets on (Team A −2.5 goals), and:
Team A loses the match by any margin, then the participant loses the bet.
The match results in a draw, then the participant loses the bet.
Team A only wins by 1 goal, then the participant loses the bet.
Team A only wins by 2 goal, then the participant loses the bet.
Team A wins by more than 2 goal (3 or more goals), then the participant wins the bet.

In the “Asian Handicap” market, the participant will not earn a larger reward or payout if the winning margin of Team A increases beyond 3 goals. The reward or payout for a winning bet will remain at odds of 17 regardless of the margin of win (i.e. if Team A wins by 3 or 6 goals). If the participant places a bet on (Team B −2.5 goals), the participant predicts that Team B is going to win by more than 2.5 goals at odds of 9. Again, since half a goal cannot be scored in football, this means that the participant predicts that Team B will win the game by more than 2 goals (3 or more goals). The same logic regarding losing or winning the bet and the consequential reward or payout can be applied to a participant betting on the Team B −2.5 goals.

The present invention (the “Hybrid Wager Market”, indicated by the arrows), however, offers high odds with minimised risk. This is reflected by the odds offered for an array of outcomes by the “Hybrid Wager Market” in FIG. 4. In particular, a participant has the option of placing a bet on Team A or on Team B. If the participant places a bet on Team A, the participant can view what the odds are depending on the outcome of the match. The same can be observed if the participant places a bet on Team B. As described, the present invention offers varying odds depending on the different possible outcomes in the array of possible outcomes. These odds are clearly displayed at the time when the bet is placed, and it remains fixed from that point forward. The possible outcomes range from a margin of victory, loss or a draw. Therefore, with the “Hybrid Wager Market”, although the risk of losing the entire amount bet does not cease to exist, the risk involved in a bet on high odds (for a large payout) is reduced. For this specification, “risk” can be defined to be the probability of losing all or the majority of the stake that a participant wagers on a market (the higher the probability, the higher the risk). With the present invention, it is not a win or lose situation. A participant can still earn money if their team wins by a small margin, and their upside potential increases as the margin of victory for their team increases.

### Example 1

Referring to FIG. 4, assume a participant decides to bet on Team A on a handicap of −2.5 on the “Asian Handicap” market, then if:
Team A loses the match by any margin, then the participant loses the bet and loses their entire stake.
The match results in a draw, then the participant loses the bet and loses their entire stake.
Team A only wins by 1 goal, then the participant loses the bet and loses their entire stake.
Team A only wins by 2 goal, then the participant loses the bet and loses their entire stake.
Team A wins by more than 2 goals (3 or more goals), then the participant receives a payout at odds of 17 (that is a 1600% return on investment).

In contrast, still referring to FIG. 4, if the participant had bet on Team A using the present invention, the “Hybrid Wager Market”, then if:
Team A loses the match by any margin, the participant loses the bet and loses their entire stake.
The match results in a draw, the participant loses the bet and loses their entire stake.
Team A wins by 1 goal, the participant receives a payout at odds of 1.26 (that is a 26% return on investment).
Team A wins by 2 goals, the participant receives a payout at odds of 2.1 (that is a 110% return on investment).
Team A wins by 3 goals, the participant receives a payout at odds of 5.1 (that is a 410% return on investment).
Team A wins by 4 goals, the participant receives a payout at odds of 13.7 (that is a 1270% return on investment).
Team A wins by more than 4 goals (5 goals or more), the participant receives a payout at odds of 40.2 (that is a 3920% return on investment).

### Example 2

Referring to FIG. 4, assume a participant decides to bet on Team B on a handicap of −2.5 on the “Asian Handicap” market, then if:
Team B loses the match by any margin, the participant loses the bet.
The match results in a draw, the participant loses the bet and loses their entire stake.
Team B only wins by 1 goal, the participant loses the bet and loses their entire stake.
Team B only wins by 2 goal, the participant loses the bet and loses their entire stake.
Team B wins by more than 2 goals (3 or more goals), the participant wins the bet at odds of 9 (that is an 800% return on investment).

In contrast, still referring to FIG. 4, if the punter had bet on Team B using the present invention, the “Hybrid Wager Market”, then if:
Team B loses the match by any margin, the participant loses the bet and loses their entire stake.
The match results in a draw, the participant loses the bet and loses their entire stake.
Team B wins by 1 goal, the participant receives a payout at odds of 0.94 (that is a −6% return on investment).
Team B wins by 2 goals, the participant receives a payout at odds of 1.67 (that is a 67% return on investment).
Team B wins by 3 goals, the participant wins the bet at odds of 2.96 (that is a 196% return on investment).
Team B wins by 4 goals, the participant wins the bet at odds of 8.4 (that is a 740% return on investment).
Team B wins by more than 4 goals (5 goals or more), the participant wins the bet at odds of 10.2 (that is a 920% return on investment).

In Example 2 above, the participant will receive 94% of the amount wagered in return as the reward if the outcome is Team B win by 1 goal, whereas he will receive 167% of the amount wagered in return as the reward if the outcome is Team B win by 2 goals. If the participant had wagered on Team B with a handicap of −2.5 on the “Asian Handicap” market, then the participant would have lost his entire stake for Team B win by 1 or 2 goal outcomes. Therefore, by placing a bet on the present “Hybrid Wager Market”, the participant has a chance of receiving a large reward if the outcome is a large margin of win for the team the participant wagered on to win. Thus, during the game, each unanswered goal scored by the team that the participant wagered on increases their payout reward (where “unanswered” means that the opposing team does not score a goal after the punters team scored a goal).

In these examples, where the pivot is placed on the draw, if the game outcome is a small margin of win for the team the participant wagered on, the participant will still receive a small reward which will most likely yield a small return on investment. The participant will not lose the amount wagered entirely. Thus, with present “Hybrid Wager Market”, if the game is a close one, the participant can still hope for a late goal for his team in order to secure a reward. If the participant had wagered on an “Asian Handicap” of −2.5 and the score is 1-1 with 15 minutes left to play, then the bet is all but lost. The probability of his team scoring 3 goals in 15 minutes is unlikely and close to zero.

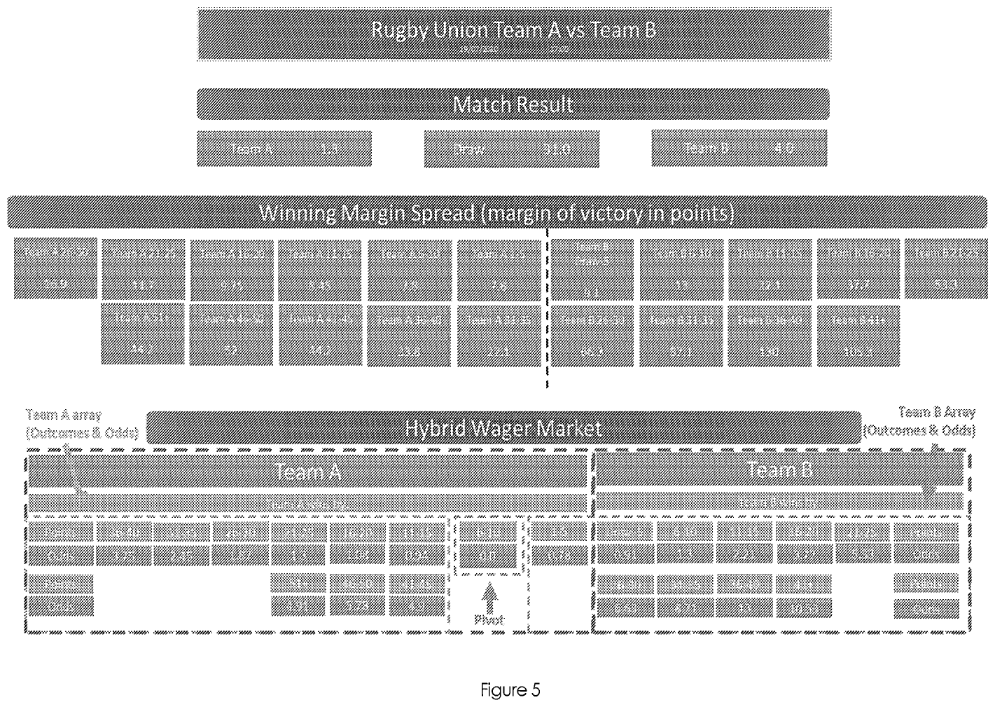

FIG. 5 further illustrates how the Hybrid Wager Market of this invention offers participants the potential of receiving a large reward, while simultaneously limiting the downside risk associated with the bet. FIG. 5 relates to a game between two rugby teams as part of the Rugby Union, in which Team A is a favourite to win. In this example of the Hybrid Wager Market, the pivot falls on Team A win by 6-10 points. Therefore, the first element in the first group of outcomes is a Team A win by 11-15 points. Thus, a win by Team A of 16 points or more would also fall under the first group of outcomes. The first element in the second group of outcomes is Team A win by only 1-5 points. Thus, a draw or a Team B win by any margin would also fall in the second group of outcomes. Importantly, the possible outcome in the array of outcomes of Team A wins by 1-5 points falls under the second group of outcomes. A participant will have full access to the details of the groups of outcomes and the associated odds before placing a bet on a particular group of outcomes.

### Example 3

Referring to FIG. 5, assume a participant decides to bet on Team A by 31-35 points on the “Winning Margin Spread” market, then if:
Team A loses the match by any margin, the participant loses the bet and loses their entire stake.
The match results in a draw, the participant loses the bet and loses their entire stake.
Team A wins by 1-5 points, then the participant loses the bet and loses their entire stake.
Team A wins by 10-15 points, then the participant loses the bet and loses their entire stake.
Team A wins by 16-20 points, then the participant loses the bet and loses their entire stake.
Team A wins by 21-25 points, then the participant loses the bet and loses their entire stake.
Team A wins by 26-30 points, then the participant loses the bet and loses their entire stake.
Team A wins by 31-35 points, then the participant wins the bet at odds of 22.1 (that is a 2110% return on investment).
Team A wins by 36 or more points, then the participant loses the bet and loses their entire stake.

In contrast, still referring to FIG. 5, if the participant had bet on Team A group of outcomes using the present invention, the “Hybrid Wager Market”, then if:
Team A loses the match by any margin, the participant loses the bet and loses their entire stake.
The match results in a draw, the participant loses the bet and loses their entire stake.
Team A only wins by 1-10 points, the participant loses the bet and loses their entire stake.
Team A wins by 11-15 points, then the participant receives a payout at odds of 0.94 (that is a −6% return on investment).
Team A wins by 16-20 points, then the participant receives a payout at odds of 1.08 (that is an 8% return on investment).
Team A wins by 21-25 points, then the participant wins the bet at odds of 1.3 (that is a 30% return on investment).
Team A wins by 26-30 points, then the participant wins the bet at odds of 1.87 (that is a 87% return on investment).
Team A wins by 31-35 points, then the participant wins the bet at odds of 2.45 (that is a 145% return on investment).
Team A wins by 36-40 points, then the participant wins the bet at odds of 3.75 (that is a 275% return on investment).
Team A wins by 41-45 points, then the participant wins the bet at odds of 4.9 (that is a 390% return on investment).
Team A wins by 46-50 points, then the participant wins the bet at odds of 5.78 (that is a 478% return on investment).
Team A wins by more than 50 points (51 points or more), then the participant wins the bet at odds of 4.91 (that is a 391% return on investment).

Therefore, the greater the margin of win in points by Team A, the greater the payout to participants who bet on the Team A group of outcomes. Note that, in this example, the odds of Team A to win by more than 50 points at 4.91 is less than the odds of Team A to win by a margin of 46-50 points at 5.78. This is because, in this example, the bookmakers predict there is a higher probability of Team A winning by 50 points or more, than for Team A to win by a margin of 46-50 points. This is an occurrence that can be seen quite often between the last two elements in a group of outcomes for the Hybrid Wager Market.

A person skilled in the art will appreciate that it is essential that the markets are priced correctly to ensure profitability of the Hybrid Wager Market invention. In this context correctly priced markets mean that the true probability of each outcomes was calculated with great precision. The more accurate the calculations of the true odds are for each outcome the higher the probability that the bookmaker will make a profit after pricing the odds to the punter with a built in vigorish. The HWM is no different to current sports betting markets in the following way: It is highly dependent on the accurate calculation of the true odds of the various outcomes. This accuracy is required in order to price up market odds that are offered to punters in a way that will maximise the probability of the bookmakers making a profit in the long run.

The odds for the possible outcomes in the array of possible outcomes can be recalculated at the time of each bet (i.e. calculating odds (16) can be iteratively executed each time a participant accesses or views the odds). For example, the injury of a key player before a game would affect the possibility of a team winning. Thus, the odds of winning outcomes would be adjusted accordingly. Therefore, calculating the odds in step 16 can be iterated on each viewing by a participant so that the participant views the updated odds. Once a participant bets on those odds, the odds are fixed for that bet and are captured for later reference (as described below). It is to be appreciated that the probability of each particular outcome used to calculate odds for the possible outcomes may vary over time and as such, calculating the array of odds for the array of possible outcomes may be iterated accordingly. The input probabilities for each particular outcome used to calculate the odds can either be calculated by a bookmaker or it can be sourced from a third party.

Referring back to FIG. 1, step 16 further includes storing the array of odds (110) associated with each possible outcome in the array of possible outcomes (102) in an odds database (100), after such odds (110) have been calculated. The odds database (100) can thus be similar to the table shown in FIG. 3, including the array of possible outcomes of the game (102) and the array of odds (110) associated with each possible outcome as calculated. The odds database can be stored on a remote server.

At 18, the method (10) includes the step of receiving bets from a plurality of participants until a predefined cut off time. The predefined cut off time may be before the start of the game or may be at any stage during play of the game, depending on the outcome to which the bets relate. The predefined cut off time may be associated with or may be determined based on an outcome to which a bet or wager relates. For example, the outcome might be the winner of lap 56 and the predefined cut off time might be the beginning of lap 56. The term “bet” (also referred to as a “wager”) has the conventional meaning of money being placed/staked by a participant on a predicted outcome of a contingency. Each bet relates to either the first group of outcomes (104) or the second group of outcomes (108). As such, in FIGS. 3 and 4, due to the position of the pivot (106) each bet relates to a predicted winning team (either Team A or Team B).

In this example, the step of receiving bets (18) includes receiving from each participant: an identifier of the participant (e.g. a unique alphanumerical code), a bet indicator, an amount wagered (or “stake”) by the participant in that particular bet. The bet indicator is associated with either first group of outcomes or the second group of outcomes, and in turn is associated with the odds (110) associated with that group of outcomes, the odds corresponding to the margin of win within the group of outcomes. Receiving bets (18) also includes receiving a unique identifier associated with each bet or wager received. In this regard, participants can make multiple wagers on one game and the unique identifier associated with each bet provides for future reference when wager queries are involved.

It is to be appreciated that the identifier of the participant can be omitted from the information received (18) in examples where participants receive a betting slip confirming a bet received, such that a successful participant can retrieve a reward on presentation of a winning betting slip.

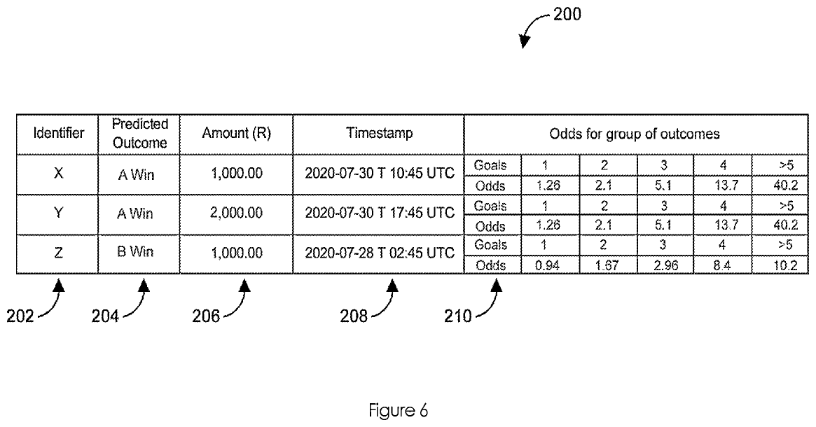

Step 18 further includes storing the bets received from the plurality of participants. The bets are stored on a game wagers database (200) on a remote or local server. This database (200), an example of which is shown in FIG. 6, includes the identifiers (202) of all of the participants who have placed bets on a particular game, the bet indicator for the particular group of outcomes (204) on which each participant wagered on (i.e. either Team A win or Team B win, in this example) and the amount wagered (206) on that particular outcome by the participant. As shown, the timestamp (208) of the bet is also stored, together with the odds (210) offered for that group of outcomes (204) at that time of the bet. Bets from participants are received and stored (16) up until the cut off time before the game.

At 20, the method (10) includes the step of receiving a game outcome associated with a particular outcome in the array of possible outcomes (102), the game outcome falling within either the first group of outcomes (104) or the second group of outcomes (108) or the pivot (106). In this example, the game outcome is received (18) after the game has occurred and includes the final game score between the two parties. Step 20 further includes storing the game outcome on the game wagers database associated with the particular game.

It is to be appreciated that the game outcome is not limited to the final score of the game. The game outcome can also be received at any point during or after the game. For example, the game outcome can be received at halftime (i.e. the game outcome is the halftime score) or after a prescribed event in the game (e.g. the game outcome is the score after a single set), etc. Any game outcome which reflects the position between two parties at a predetermined point and which can be wagered on can form the game outcome.

At 22, the method (10) includes the step of calculating rewards due to participants wherein at least those participants who bet on the group of outcomes in which the game outcome falls are rewarded based on the odds calculated for the game outcome. Bets received and stored in the game wagers database (200) associated with the particular game are retrieved and the rewards due to each participant who bet on the winning group of outcomes is calculated. All participants who bet on the winning group of outcomes are rewarded based on the odds of the game outcome at the time of their respective bet.

FIG. 3 read with FIG. 6 illustrates this correlation which determines the reward due to each participant who bet on the winning group of outcomes. As shown in FIG. 3 at (18), three bets are received (see FIG. 6) from three separate participants (202) as follows: Participant X bets R1,000 on Team A to win; Participant Y bets R2,000 on Team A to win; and Participant Z bets R1,000 on Team B to win. No further bets are accepted after the cut off time. After the game has occurred, the game outcome is received (20), which indicates that Team A has won by a 1 point margin.

The correlation between Participant X's bet (204) on the A win group of outcomes and the game outcome is a winning bet and Participant X will be entitled to a reward based on the odds at the time of the bet. As such, Participant X's reward will be R1,260. The correlation between Participant Y's bet (204) on the A win group of outcomes and the game outcome is a winning bet and Participant Y will be entitled to a reward based on the odds at the time of the bet. As such, Participant Y's reward will be R2,520. The correlation between Participant Z's bet (204) on the B win group of outcomes and the game outcome is a losing bet and Participant Z will not be entitled to a reward.

In this example, the rewards are in the form of credits, specifically credits allocated to an electronic wallet of the participant.

At 24, the method (10) includes the final step of facilitating reward transfer to the plurality of participants with winning bets on the game. As in this example the rewards are credits allocated to an electronic wallet, this step (24) includes allocating a credit amount to the relevant electronic wallet, from which monetary payouts (cash, via electronic funds transfer or via cryptocurrency transfer) can be requested by the relevant participant.

The method (10) ends at 26.

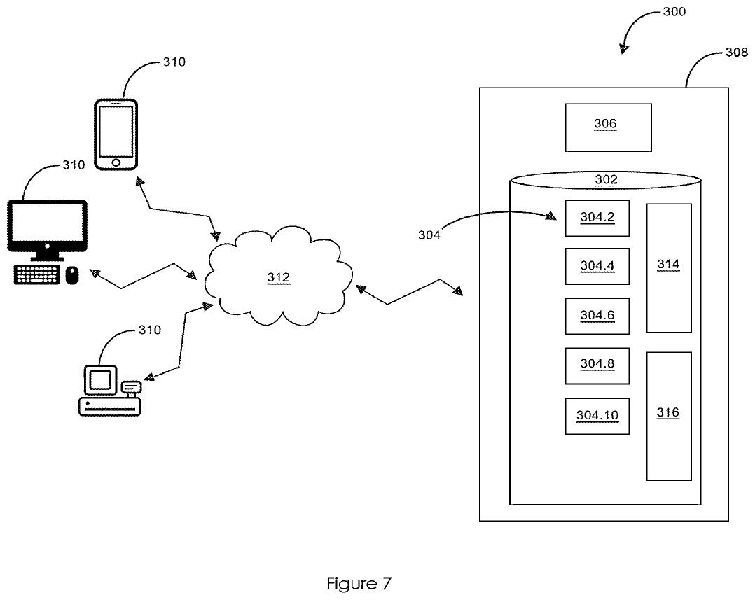

As shown in FIG. 7, the invention extends to provide a betting system (300) which is capable of operating a betting market for sports or e-sports.

The betting system (300) includes a digital storage facility (302) which stores executable instructions (304). The digital storage facility (302) can include one or more cooperating memories: random access memory (RAM) and derivatives thereof (e.g. DRAM, FCRAM or SRAM), read-only memory (ROM) and derivatives thereof (e.g. EPROM or EEPROM) and field-programmable gate arrays (FPGAs); as well as other microcontrollers or microprocessors.

When executed, the executable instructions (304) perform the steps of:
at (304.2), receiving game details for a game scheduled between two parties, the game details including at least probabilities of each outcome in an array of possible outcomes of the game;
at (304.4), calculating an array of odds for the array of possible outcomes of the game based on the game details, with the odds for each particular outcome in the array of possible outcomes being based on a probability of each particular outcome and determining a pivot in the array of possible outcomes based on the odds, with a first group of outcomes defined on one side of the pivot and a second group of odds defined on an opposed side of the pivot;
at (304.6), receiving bets from a plurality of participants, each bet relating to either the first group of outcomes or the second group of outcomes, until a predefined cut off time before the start of the game;
at (304.8), receiving a game outcome associated with a particular outcome in the array of possible outcomes, the game outcome falling within either the first group of outcomes or the second group of outcomes; and
at (304.10), calculating rewards due to each participants, wherein at least those participants who bet on the group of outcomes in which the game outcome falls are rewarded based on the odds calculated for the game outcome.

Although not specifically shown, the executable instructions (304) further include: storing the array of odds associated with each outcome in the array of possible outcomes in an odds database; storing the bets received from the plurality of participants on a game wagers database; disseminating odds for the array of possible outcomes; and facilitating reward transfer to the plurality of participants with winning bets on the game.

The betting system (300) also includes a processor (306) which is coupled to the digital storage facility (302) and which is operable to execute the executable instructions (304). The processor (306) can be a CPU, a microprocessor or multiple cooperating processors, hosted on a server (308). In this example, the server (308) in the form of a remote, cloud-based server.

The betting system (300) also includes a plurality of user devices (310) which are in communication with the server (308) over the Internet (312). As shown, the plurality of user devices (310) include mobile telephones, personal computers, or any electronic hand held devices, and point of sales devices, which participants can use in order to place their bets. As long as the user device (310) can communicate with the Internet (312), such a device can be used to place a bet. It is to be appreciated that the present betting market can be integrated with an existing betting interface which participants access in order to view various betting markets available for a particular game.

The betting system (300) yet further includes an odds database (314) and a game wagers database (316), hosted on the digital storage facility (302). The odds database (314) stores the following data related to a particular game: the array of possible outcomes of the game and the odds associated with each outcome (as calculated at 304.4). The game wagers database (316) stores the following data related to the particular game: identifiers of the participants who have placed bets on the game, the bet indicator of the group of outcomes on which each participant wagered on, the amount wagered on that particular group of outcomes by the participant, the timestamp of the bet, the odds offered for each outcome in the group of outcomes at the time of that bet and the unique identifier associated with each particular bet.

The betting system (300) is capable of administering a betting market in accordance with the description of the method (10).

The inventor believes that the present invention provides a dynamic betting market that offers pre-determined, transparent, and increasing payout amounts on a single winning bet depending on the margin of victory (goals/points/other score metric) for the participants player/team that they have backed. The participant is also never at risk of losing more than the amount wagered for any given bet placed on the market. The betting market also provides the participant the possibility of receiving a payout which increases exponentially as the margin of victory of the bet (i.e. the group of outcomes selected) increases, whilst simultaneously mitigating the risk associated with losing all or part of their stake wagered.

1.-56. (canceled)

57. A computer-implemented method of administering a betting market for sports, the method including the steps of:
receiving game details for a game between two parties, the game details including at least probabilities of each outcome in an array of possible outcomes of the game;
calculating an array of odds based on the game details;
determining a pivot in the array of possible outcomes based on the array of odds, with at least one group of outcomes to one side of the pivot;
receiving bets from a plurality of participants, each bet relating to at least one group of outcomes, until a predefined cut off time (associated with the outcome);
receiving a game outcome associated with a particular outcome in the array of possible outcomes, the game outcome falling within the at least one group of outcomes, or on the pivot; and
calculating rewards due to participants, wherein at least those participants who bet on the group of outcomes in which the game outcome falls are rewarded based on the odds calculated for the game outcome.

58. A method as claimed in claim 57, which includes two groups of outcomes with a first group of outcomes defined on one side of the pivot and a second group of odds defined on an opposed side of the pivot.

59. A method as claimed in claim 57, which includes calculating probabilities of each possible outcome in the array of possible outcomes of the game.

60. A method as claimed in claim 59, in which calculating the probabilities of each possible outcome includes receiving statistical data from a third party and running the statistical data through an algorithm to determine the probabilities of each outcome.

61. A method as claimed in claim 57, in which the step of calculating the array of odds for the array of possible outcomes of the game includes determining the array of possible outcomes with the odds for each particular outcome in the array of possible outcomes being based on at least a probability of each particular outcome.

62. A method as claimed in claim 58, in which the first group of outcomes and the second group of outcomes are capped at a predetermined range from the pivot.

63. A method as claimed in claim 57, in which the first group of outcomes and the second group of outcomes each include two or more possible outcomes for the game, with each outcome having particular odds with the first group of outcomes and the second group of outcomes divided into a sequential margin of win outcomes respectively, with each margin forming an element in the array of possible outcomes and providing a particular outcome of the game, and with any one of the particular outcomes grouped in a range of discrete outcomes.

64. A method as claimed in claim 57, in which the step of calculating the array of odds for the array of possible outcomes of the game is based on any one of historical betting patterns and real time betting patterns of a bookmaker's clients and an incorporation of a vigorish into the array of odds.

65. A method as claimed in claim 57, which includes storing the array of odds for the array of possible outcomes in an odds database in the form of a digital storage facility, the odds database including the array of possible outcomes of the game and the array of odds associated with each possible outcome, as calculated.

66. A method as claimed in claim 58, in which the step of determining a pivot in the array of possible outcomes includes determining an outcome which will distinguish between the first group of outcomes and the second group of outcomes.

67. A method as claimed in claim 66, in which the pivot represents a point in the array of possible outcomes for the game where participants who wagered on the first group of outcomes will lose the entire amount wagered if the game outcome lands on or past the pivot into the second group of outcomes, and in which participants who wagered on the second group of outcomes will lose the entire amount wagered if the game outcome lands on or past the pivot and results in a game outcome that falls in the first group of outcomes.

68. A method as claimed in claim 67, in which the pivot is determined based on any one or more of the most likely outcome for a game, prior knowledge of the prevailing betting trends of participants, a predicted outcome where equal amounts of wagers are placed on either side of the pivot, and at the spread line representing the expected margin of victory or total amount of points expected to be scored.

69. A method as claimed in claim 68, in which the step of receiving bets from a plurality of participants includes receiving from each participant at least event details, an identifier of the participant, a bet indicator being associated with any one of the first group of outcomes and the second group of outcomes, an amount wagered by the participant, and a unique indicator associated with that bet.

70. A method as claimed in claim 69, in which the bet indicator which is associated with either the first group of outcomes or the second group of outcomes, is associated with odds associated with that group of outcomes, the odds corresponding to any one of the margin of win within the group of outcomes and a total count of an occurrence of a predefined event.

71. A method as claimed in claim 70, which includes bets related to the pivot, which falls between the first group of outcomes and the second group of outcomes.

72. A method as claimed in claim 57, which includes the intermediate step of storing the bets received from the plurality of participants on a game wagers database in a digital storage facility, after the step of receiving bets from a plurality of participants, the game wagers database including at least an identifier of the participant, a bet indicator indicating the group of outcomes wagered on, the event details, an amount wagered by the participant, the odds of the possible outcomes in the group of outcomes wagered on by the participant for that bet, a unique indicator associated with that bet and the game outcome.

73. A method as claimed in claim 57, in which the game outcome is received at any one of: after the game has occurred, at halftime, after a predetermined amount of time has elapsed, and after a prescribed event in the game.

74. A betting system arranged to operate a betting market for sports, which includes
a digital storage facility for storing executable instructions, which when executed performs the steps of:
receiving game details for a game scheduled between two parties, the game details including at least probabilities of each outcome in an array of possible outcomes of the game;
calculating an array of odds for the array of possible outcomes of the game based on the game details, with the odds for each particular outcome in the array of possible outcomes being based on at least a probability of each particular outcome;
determining a pivot in the array of possible outcomes based on the array of odds, with at least one group of outcomes to one side of the pivot;
receiving bets from a plurality of participants, each bet relating to at least one group of outcomes, until a predefined cut off time (associated with the outcome);
receiving a game outcome associated with a particular outcome in the array of possible outcomes, the game outcome falling within the at least one group of outcomes, or on the pivot; and
calculating rewards due to participants, wherein at least those participants who bet on the group of outcomes in which the game outcome falls are rewarded based on the odds calculated for the game outcome;
a processor which is operable to execute the executable instructions, the processor being hosted on a server; and
a plurality of user devices which are in communication with the server and on which participants can place their bets.

75. A betting system as claimed in claim 57, in which the digital storage facility includes executable instructions, when executed, to define two groups of outcomes with a first group of outcomes defined on one side of the pivot and a second group of odds defined on an opposed side of the pivot.

76. A betting system as claimed in claim 74, in which the plurality of user devices are in the form of any one of: mobile telephones, personal computers, iPad's and point of sales devices in communication with the server.
